(19) United States
(12) Patent Application Publication
(10) Pub. No.: US 2013/0251492 A1
(43) Pub. Date: Sep. 26, 2013

(54) Transferring Apparatus for Glass Substrate

(71) Applicants: Xiande Li, Shenzhen (CN); Chun Hao Wu, Shenzhen (CN); Kun Hsien Lin, Shenzhen (CN); Yongqiang Wang, Shenzhen (CN); Erqing Zhu, Shenzhen (CN); Weibing Yang, Shenzhen (CN)

(72) Inventors: Xiande Li, Shenzhen (CN); Chun Hao Wu, Shenzhen (CN); Kun Hsien Lin, Shenzhen (CN); Yongqiang Wang, Shenzhen (CN); Erqing Zhu, Shenzhen (CN); Weibing Yang, Shenzhen (CN)

(73) Assignee: SHENZHEN CHINA STAR OPTOELECTRONICS TECHNOLOGY CO, LTD., Shenzhen (CN)

(21) Appl. No.: 13/521,983

(22) PCT Filed: Mar. 31, 2012
(86) PCT No.: PCT/CN12/73420

§ 371 Date: Jul. 12, 2012

(30) Foreign Application Priority Data
Mar. 23, 2012 (CN) 201210081669.9

(51) Int. Cl. B65G 47/91; B65G 47/90

(52) U.S. Cl. 414/752.1; 414/749.1; 414/753.1; 414/751.1

(57) ABSTRACT

This invention discloses a transferring apparatus for transferring a glass substrate from a cartridge in case the glass substrate disposed therein is damaged or defective. The transferring apparatus includes a chassis, and a conveying device. The conveying device includes a frame and a plurality of transferring rods arranged in a common plane and along a longitudinal direction. A first driving device disposed on the chassis and is interlinked with the conveying device. The first driving device moves the frame along the first horizontal direction such that the frame can be moved in and out from the cartridge to carry the damaged glass substrate. The driving device further drives the transferring rods to rotate centered with its own axis. By the provision of the transferring apparatus, a damaged or defective glass substrate can be properly transferred out of the cartridge without damaging adjacent glass substrate. This can be performed automatically so as to increase the efficiency, while reducing labors.

### FIELD OF THE INVENTION

The present invention relates to a liquid crystal display, and more particularly, to a transferring apparatus for a glass substrate.

### BACKGROUND OF THE INVENTION

In the existing technology of making a liquid crystal display, a glass substrate has to be transferred from a cartridge, on which a plurality of glass substrates are juxtaposed or piled up, to a production line in which a plurality of different processes are performed on the glass substrate so as to complete a panel. However, the thickness of the glass substrate is merely about 0.4 to 0.7 mm, and it is very brittle to crack. As a result, a check up process has to be performed during the transferring of the glass substrate onto the production line.

Currently, once a damage or defective is found on the glass substrate during transferring, the cartridge has to be moved onto a carrier manually. Then, an evaluation will be conducted so as to determine how to best utilize the glass substrate based on the position of the damage or defective. In general, a small recycle tray is placed onto the insulating plate, and then a scissor is used to cut the glass substrate into a plurality of small pieces for other applications. Then, those small sized glass substrates are collected into the recycle tray. Then, a glass substrate under the damaged glass substrate is exposed, and will be vacuumed and wiped with dust-free cloth so as to make sure there is no debris left over. The recycle tray is then moved to a bigger recycle box in which all the small sized glass substrate are stocked.

An extensive laborious works have to be involved, and in addition, it takes a lot of time. On the other hand, when the damaged or defective glass substrate is cut with scissor, the other glass substrate can be readily damaged, creating unnecessary second damages to the glass substrate.

It is therefore a necessity to provide a pickup device for transferring the glass substrate so as to resolve the current issues.

### SUMMARY OF THE INVENTION

The present invention provides a transferring apparatus so as to resolve a technical issue in manufacturing a liquid crystal display. A damaged glass substrate or its debris can be readily and conveniently removed out of a cartridge in which the glass substrates are stored.

Accordingly, a transferring apparatus is provided for transferring a glass substrate out from a cartridge in which the glass substrate is stored, or removal of debris of damaged glass substrate. The apparatus comprises a chassis. A conveying device is provided and includes a frame a plurality of transferring rods which are located at a common plane, and vertically arranged and spaced over the frame. A first driving device is disposed on the chassis and interlinked to the plurality of rods. Wherein the driving device moves the plurality of rods horizontally along a first horizontal direction such that the plurality of rods are moved in and out of a cartridge on which glass substrates are carried along the first horizontal direction, the driving device further rotating each of the transferring rods centered on its own axis.

Wherein the conveying device is configured with first and second frames arranged on each side, and each of the first and second frame is arranged with the plurality of transferring rods directed toward each other.

Wherein the conveying device further includes a plurality of rollers disposed on the transferring rods, and rotated synchronically with the transferring rods.

Wherein the frame further includes a transaxle disposed along a longitudinally along the first frame, the transaxle is provided with a plurality of first driving gears with respect to each of the transferring rods, each of the transferring rods is provided with a second follower gear meshed with the first driving gear, the follower gears are driven by the first driving gears so as to rotate the transferring rods.

Wherein the transferring apparatus further includes a collecting device disposed securely on the first frame and located adjacent to the conveying device, the collecting device is used to collect a damaged glass substrate or debris of glass substrate.

Wherein the collecting device further includes a plurality of rollers, which is located above the collecting device and are rotated with respect to the collecting device.

Wherein the transferring apparatus further includes a second driving device, with the driving power from the second driving device, the conveying device, the first driving device and the collecting device are moved vertically with respect to the chassis.

Wherein the first driving device further drives the transferring rods to flip over the collecting device and sits onto the collecting device.

Wherein the transferring apparatus further includes an automatic holding device which can securely get hold of the cartridge which is moved in or out from the first horizontal direction and a second horizontal direction which is perpendicular to the first horizontal direction so as to transfer the defective glass substrate our of the cartridge of the glass substrate.

Wherein the automatic holding device further includes a first slide disposed on the chassis and which can slide on the chassis along the first horizontal direction, and a second slide moveably disposed on the first slide along the second horizontal direction.

Wherein the automatic holding device includes a pickup arm, and nozzle or tweezers disposed onto the pickup arm.

Wherein the collecting device includes a plurality of supporting rods alternatively arranged, the supporting rods defines slots allowing passing of the first and second slides, wherein the top surface of the second slide is lower then a top surface of the supporting rods.

Wherein a third driving device is provided to power the automatic holding device.

According to a second embodiment of the present invention, a transferring apparatus for transferring damaged glass substrate or debris from a cartridge is provided and it comprises a chassis, and a conveying device configured with first and second frames. A plurality of first and second transferring rods are disposed along the longitudinal direction of the frames, and each of the first and second transferring rods is spaced from each other. A first driving device is disposed on the chassis and interlinked to the transferring rods with both ends. Each of the first and second transferring rods is directed toward to face each other. A collecting device is disposed on the chassis and located adjacent to the conveying device. Wherein the first driving device drives the first and second frames along the horizontal direction such that the transferring rods moves in or out of the cartridge, the first driving device further drives the first and second transferring rods to rotate centered on its own axis.

Wherein the conveying device further includes rollers disposed on the first and second transferring rods, and which are synchronically rotated with respect to the transferring rods.

Wherein the frame further includes a transaxle disposed along a longitudinally along the frame, the transaxle is provided with a plurality of first driving gears with respect to each of the first and second transferring rods, each of the first and second transferring rods is provided with a second follower gear meshed with the first driving gear, the follower gears are driven by the first driving gears so as to rotate the first and second transferring rods.

Wherein the collecting device further includes a plurality of rollers, which is located above the collecting device and are rotated with respect to the collecting device.

Wherein the transferring apparatus further includes a second driving device, with the driving power from the second driving device, the conveying device, the first driving device and the collecting device are moved vertically with respect to the chassis.

Wherein the automatic holding device further includes a first slide disposed on the chassis and which can slide on the chassis along the first horizontal direction, and a second slide moveably disposed on the first slide along the second horizontal direction, wherein the automatic holding device includes a pickup arm, and nozzle or tweezers disposed onto the pickup arm.

The advantages of the present invention is the transferring apparatus can readily access to the cartridge so as to remove the damaged glass substrate or its debris in a single operation which is far to reach by the existing technology. Accordingly, the transferring apparatus can be fully automatic with shortened cycle time, while entertains great efficiency. On top of that, those undamaged and intact glass substrate located around will not be damaged accidentally by the removal of the damaged glass substrate.

### BRIEF DESCRIPTION OF DRAWINGS

FIG. 1 is a main illustrational view of a transferring apparatus for glass substrate made in accordance with the present invention;

FIG. 2 is a top view of the transferring apparatus shown in FIG. 1;

FIG. 3 is an enlarged view of the encircled portion A of FIG. 2;

FIG. 4 is an enlarged view of the encircled portion B of FIG. 1;

FIG. 5 is a main illustrational view of an automatic holding device of the transferring apparatus for glass substrate;

FIG. 6 is an enlarged view of the automatic holding device shown in FIG. 5; and

FIG. 7 is an enlarged view of the encircled portion C of FIG. 5.

### DETAILED DESCRIPTION OF PREFERRED EMBODIMENT

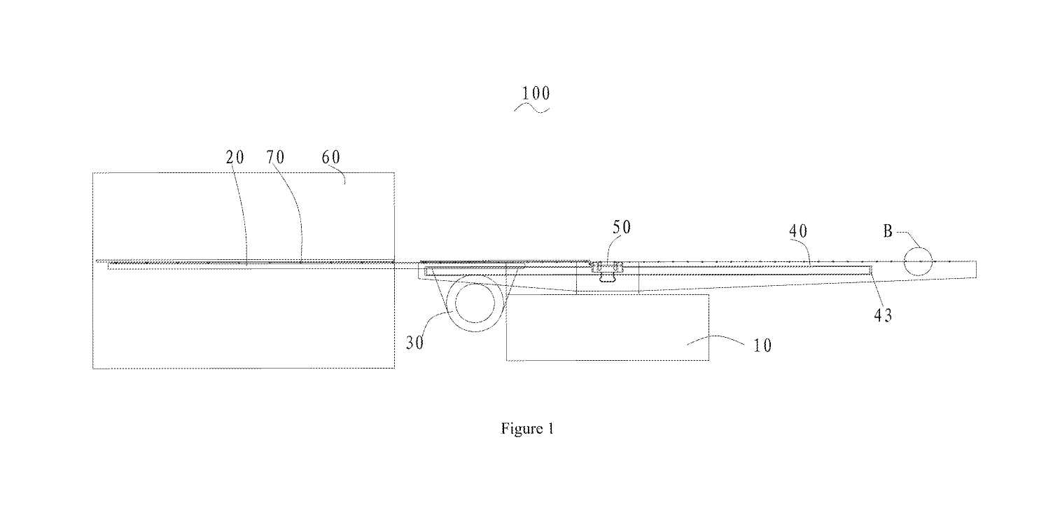

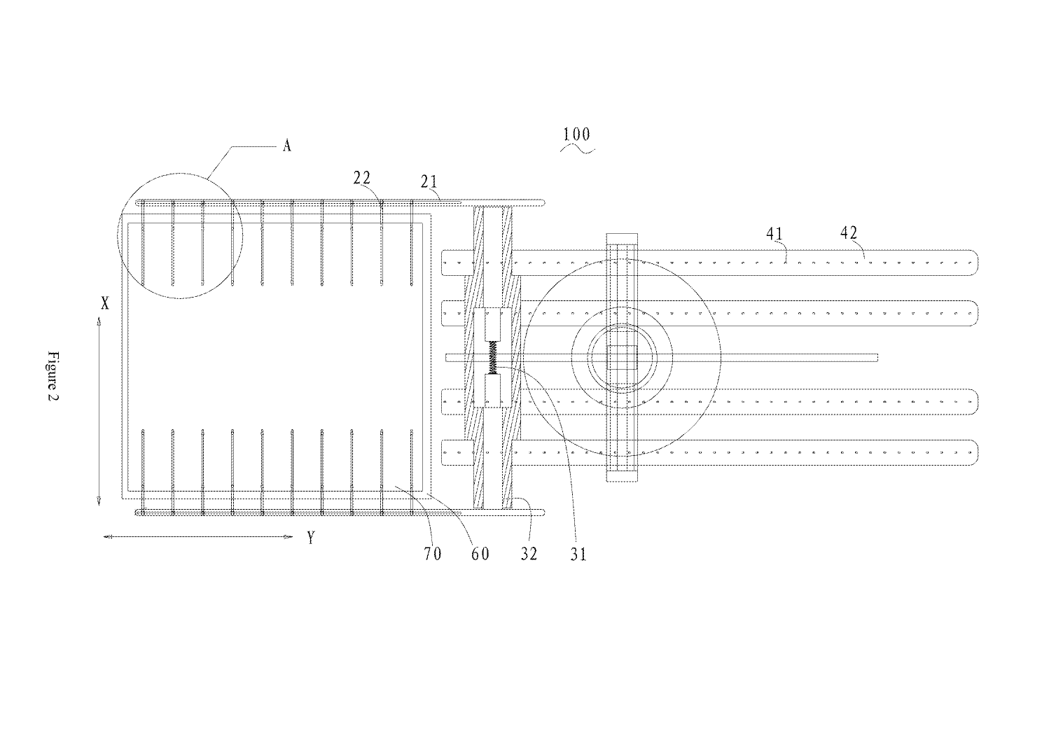

Referring to FIGS. 1 to 3, a transferring apparatus 100 made in accordance with the preferred embodiment for removing a damaged glass substrate 70 or debris (not shown) from a cartridge 60 is disclosed. The transferring apparatus 100 is configured with a chassis 10, a conveying device 20, a first driving device 30, a collecting device 40, an automatic holding device 50, a second driving device (not shown in these Figures), and a third driving device (not shown in these Figures)

The chassis 10 is disposed on the bottom of the transferring apparatus 100, and which is used to support the other parts. In the preferable embodiment, the chassis 10 is a disk-like plate. In order for easily moving of the chassis 10, the chassis 10 can be installed with casters (not shown) such that the chassis 10 can be moved to the place as required. In the field application, the chassis 10 can be replaced with other structure.

The first driving device 30 is installed onto the chassis 10, and is interconnected with the conveying device 20. In this embodiment, the first driving device 30 is a spring 31 and a cylinder 32.

The conveying device 20 includes a first and second frame 21 and a plurality of transferring rods 22 disposed on the transferring rods 21. Each of the transferring rods 22 is incorporated with a roller 23. The first and second frame 21 each interconnected to the ends of the cylinder 32 of the first driving device 30. Basically, the first and second frames 21 are symmetrically arranged centered on the first driving device 30. The transferring rods 22 are perpendicularly arranged with respect to the first and second frames 21, and all the transferring rods 22 are located on a common plane. The transferring rods 22 are spaced from each other along the first and second frames 21. The transferring rods 22 are pointed toward each other as they are arranged on the first and second frames 21. Each of the transferring rods 22 is provided with a pair of rollers 23 such that the rollers 23 are synchronically rotated with respect to the transferring rods 22.

The frame 21 further includes a transaxle 24 along its longitudinal direction. The transaxle 24 is provided with a first driving gear 25 with respect to each of the transferring rods 22. Each of the transferring rods 22 is also provided with a follower gear 26 meshed with the first driving gear 25.

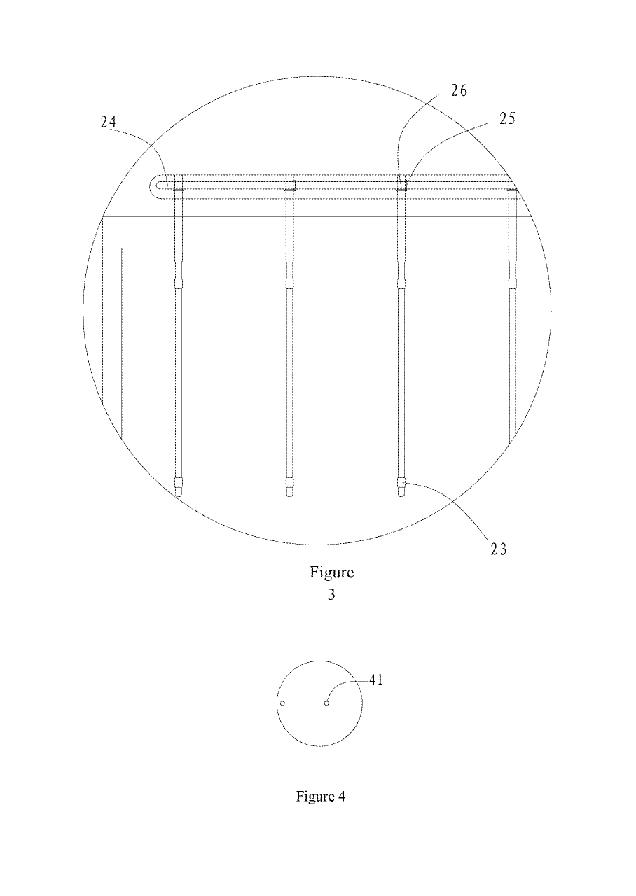

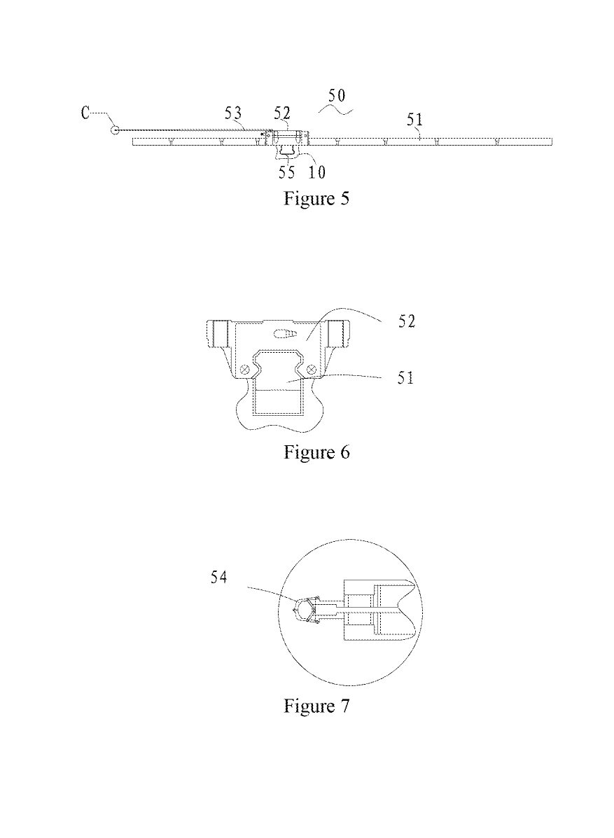

The collecting device 40 is securely attached to the chassis 10, and is located adjacent to the conveying device 20. The collecting device 40 includes a plurality of supporting rods 42. The supporting rods 42 are perpendicularly arranged with respect to the transferring rods 22. As shown in FIG. 4, a plurality of rollers 41 are arranged and projected over a top surface of the supporting rods 42. The rollers 41 can roll freely with respect to the supporting rods 42. When the supporting rods 42 are inserted into the cartridge 60, its level is flushed to the transferring rods 22, or a little bit lower than the transferring rods 22. The rollers 23 are flushed to the roller 41 or slightly higher.

Referring to FIG. 7, the automatic holding device 50 is disposed on the chassis 10, and it is configured with a first slide 51 moveably along a first horizontal direction X. A second slide 52 is moveably disposed on the first slide 51, and which can be moved along the first horizontal direction X and a second horizontal direction Y which is perpendicular to the first direction X. An arm 53 is disposed on the second slide 52, and a tweezers or nozzle 54 is disposed on the arm 53.

The trace of the first slide 51 along the first horizontal direction is limited by the first track 55. The trace of the second slide 52 along the second horizontal direction Y is limited by the first slide 51. The first track 55 is installed onto the chassis 10. The first slide 51 and the second slide 52 moveably mounted thereon can move along the first horizontal direction X along the first track 55. As shown in FIG. 1, the collecting device 40 further includes a slot 43 to allow the passing through of the first and second slides 51, 52.

Portion of the first track 55 is located within the slot 43 of the collecting device 40. When the first slide 51 and the second slide 52 move jointly within the first track 55 along the first horizontal direction X, the first slide 51 and the second slide 52 can move freely within the slot 43, and the space between two adjacent supporting rods 42. By this arrangement, the top surface of the second slide 52 will not be higher than the top surface of the supporting rods 42. As a result, when the glass substrate 70 or its debris is moved out of the cartridge, their transfer will not be hindered.

When the second slide 52 is located within the space between two adjacent supporting rods 42, the second slide 52 can move along the second horizontal direction Y on top of the first slide 51. When the second slide 52 is located within the slot 43 of the supporting rods 42, the second slide 52 is prohibited from moving along the second horizontal direction Y on the first slide 51.

The arm 53 is raised higher than the top surface of the supporting rods 42. Accordingly, by the sliding movement of the first slide 51 and the second slide 52, the tweezers 54 of the automatic holding device 50 can move in or move out of the cartridge 60 along the first horizontal direction X and the second horizontal direction Y. As a result, most of the debris in the cartridge 60 can be readily removed. The sliding movement of the first slide 51 and the second slide 52 is powered by the third driving device.

The conveying device 20, the first driving device 30, the collecting device 30, and the automatic holding device 50 can be moved vertically with respect to the chassis 10 as it is powered by the second driving device.

In operation, the first and second frame 21 is moved along the first horizontal direction X by the first driving device 30 such that the span between the first and second frames 21 can be widened or narrowed. Accordingly, the purpose of moving the transferring rods 22 of the frames 21 into the cartridge 60 and moving out of the damaged glass substrate along the first horizontal direction X can be successfully achieved.

When the transferring rods 22 are moved into the cartridge 60, the transferring rods 22 are further raised by the second driving device. As a result, the rollers 23 of the transferring rods 22 can jack up the damaged glass substrate 70 or its debris. Meanwhile, the first driving device 30 is further triggered to rotate the transaxle 24 such that the transferring rods 22 are rotated by the meshed movement of the first driving gear 25 on the transaxle 24, and the follower gear 26 on the transferring rods 22. By this joint movement and coordination of these devices, the glass substrate 70 or the debris can be readily moved out of the cartridge 70 by the roller 23.

After the damaged glass substrate 70 or the large debris is removed out of the cartridge 60 by the transferring rods 22, the damaged glass substrate 70 is further supported by the supporting rods 42 of the collecting device 40. Once the rollers 41 on the supporting rods 42 are rotated, the damaged glass substrate 70 or the large debris can be completely moved out. In order to further limit the impact to the environment, the collecting device 40 can be readily covered with a layer of insulator (not shown). As a result, the damaged glass substrate 70 or its large debris can be completely isolated without pollute the environment.

When the conveying device 20 is moving the glass substrate 70 or its debris out of the cartridge 60, the first slide 51 and the second slide 52 are located and position on a side of the collecting device 40. By this arrangement, the tweezers 54 of the arm 53 located on the second slide 52 will be out of the moving track of the glass substrate 70 or its debris when it is moved out of the cartridge 60.

When the debris of the glass substrate is removed out from the cartridge 60 by means of the transferring apparatus 100, the devices involved can completely remove the debris out of the cartridge 60. If there is still some small debris of the damaged glass substrate located within the cartridge 60, then the automatic holding device 50 powered by the third driving device can be applied. The tweezers or the nozzle 54 of the automatic holding device 50 can readily clean out most of the small pieces of the debris scattered within the cartridge 60.

When the transferring apparatus 100 is not in use, the transferring rods 22 are moved out of the cartridge 60. In addition, the first driving device 30 can move the frame 21 to flip over and juxtaposed over the collecting device 40.

The advantages of the present invention is the transferring apparatus can readily access to the cartridge so as to remove the damaged glass substrate or its debris in a single operation which is far to reach by the existing technology. Accordingly, the transferring apparatus can be fully automatic with shortened cycle time, while entertains great efficiency. On top of that, those undamaged and intact glass substrate located around will not be damaged accidentally by the removal of the damaged glass substrate.

There is some modification or alternation can be made to the transferring apparatus made in accordance with the present invention. In order to safely remove the small pieces of the debris of the glass substrate, which was left over by the transferring rods 22, the arm of the automatic holding device 50 can be modified into an arrangement rotated horizontally centered on a preset point. The first driving device 30 can be configured by a servo and a pinion and rack arrangement. In addition, the number of the rollers on the transferring rods can also be altered so as to meet the field application.

The above described is merely preferred embodiment of the present invention, and it is merely for illustration while not for limitation. As a result, any alternation and modification or any equivalents based on the specification as well as the drawings will be covered by the attached claims even they are applied to other fields of technology directly or indirectly.

1. A transferring apparatus for transferring a glass substrate out from a cartridge in which the glass substrate is stored, or removal of debris of damaged glass substrate, comprising
a chassis;
a conveying device, including a frame a plurality of transferring rods located at a common plane, and vertically arranged and spaced over the frames; and
a first driving device, disposed on the chassis and interlinked to the plurality of rods;
wherein the first driving device moves the plurality of rods horizontally along a first horizontal direction such that the plurality of rods are moved in and out of a cartridge on which glass substrates are carried along the first horizontal direction, the driving device further rotating each of the transferring rods centered on its own axis.

2. The transferring apparatus as recited in claim 1, wherein the conveying device is configured with first and second frames arranged on each side, and each of the first and second frame is arranged with the plurality of transferring rods directed toward each other.

3. The transferring apparatus as recited in claim 1, wherein the conveying device further includes a plurality of rollers disposed on the transferring rods, and rotated synchronically with the transferring rods.

4. The transferring apparatus as recited in claim 1, wherein the frame further includes a transaxle disposed along a longitudinally along the first frame, the transaxle is provided with a plurality of first driving gears with respect to each of the transferring rods, each of the transferring rods is provided with a second follower gear meshed with the first driving gear, the follower gears are driven by the first driving gears so as to rotate the transferring rods.

5. The transferring apparatus as recited in claim 1, wherein the transferring apparatus further includes a collecting device disposed securely on the frame and located adjacent to the conveying device, the collecting device is used to collect a damaged glass substrate or debris of glass substrate.

6. The transferring apparatus as recited in claim 5, wherein the collecting device further includes a plurality of rollers, which is located above the collecting device and are rotated with respect to the collecting device.

7. The transferring apparatus as recited in claim 6, wherein the transferring apparatus further includes a second driving device, with the driving power from the second driving device, the conveying device, the first driving device and the collecting device are moved vertically with respect to the chassis.

8. The transferring apparatus as recited in claim 6, wherein the first driving device further drives the transferring rods to flip over the collecting device and sits onto the collecting device.

9. The transferring apparatus as recited in claim 6, wherein the transferring apparatus further includes an automatic holding device which can securely get hold of the cartridge which is moved in or out from the first horizontal direction and a second horizontal direction which is perpendicular to the first horizontal direction so as to transfer the defective glass substrate our of the cartridge of the glass substrate.

10. The transferring apparatus as recited in claim 9, wherein the automatic holding device further includes a first slide disposed on the chassis and which can slide on the chassis along the first horizontal direction, and a second slide moveably disposed on the first slide along the second horizontal direction.

11. The transferring apparatus as recited in claim 10, wherein the automatic holding device includes a pickup arm, and nozzle or tweezers disposed onto the pickup arm.

12. The transferring apparatus as recited in claim 10, wherein the collecting device includes a plurality of supporting rods alternatively arranged, the supporting rods defines slots allowing passing of the first and second slides, wherein the top surface of the second slide is lower then a top surface of the supporting rods.

13. The conveying device as recited in claim 9, wherein a third driving device is provided to power the automatic holding device.

14. A transferring apparatus for transferring damaged glass substrate or debris from a cartridge, comprising:
a chassis;
a conveying device including first and second frames, a plurality of first and second transferring rods disposed along the longitudinal direction of the frames, and each of the first and second transferring rods are spaced from each other;
a first driving device disposed on the chassis and interlinked to the transferring rods with both ends, each of the first and second transferring rods is directed toward to face each other; and
a collecting device disposed on the chassis and located adjacent to the conveying device,
wherein the first driving device drives the first and second frames along the horizontal direction such that the transferring rods moves in or out of the cartridge, the first driving device further drives the first and second transferring rods to rotate centered on its own axis.

15. The transferring apparatus as recited in claim 14, wherein the conveying device further includes rollers disposed on the first and second transferring rods, and which are synchronically rotated with respect to the transferring rods.

16. The transferring apparatus as recited in claim 14, wherein the frame further includes a transaxle disposed along a longitudinally along the frame, the transaxle is provided with a plurality of first driving gears with respect to each of the first and second transferring rods, each of the first and second transferring rods is provided with a second follower gear meshed with the first driving gear, the follower gears are driven by the first driving gears so as to rotate the first and second transferring rods.

17. The transferring apparatus as recited in claim 14, wherein the collecting device further includes a plurality of rollers, which is located above the collecting device and are rotated with respect to the collecting device.

18. The transferring apparatus as recited in claim 17, wherein the transferring apparatus further includes a second driving device, with the driving power from the second driving device, the conveying device, the first driving device and the collecting device are moved vertically with respect to the chassis.

19. The transferring apparatus as recited in claim 18, wherein the automatic holding device further includes a first slide disposed on the chassis and which can slide on the chassis along the first horizontal direction, and a second slide moveably disposed on the first slide along the second horizontal direction, wherein the automatic holding device includes a pickup arm, and nozzle or tweezers disposed onto the pickup arm.
